(19) United States
(12) Patent Application Publication
(10) Pub. No.: US 2023/0079714 A1
(43) Pub. Date: Mar. 16, 2023

(54) 1-AMINO-1-CYCLOPROPANECARBOXYLIC ACID FOR THINNING OF FRUITS

(71) Applicant: Valent Biosciences LLC, Libertyville, IL (US)

(72) Inventors: Steve McArtney, Highland Park, IL (US); Derek D Woolard, Zion, IL (US); Michael Schröeder, Altshausen (DE); Antonieta Isabel Verdugo Matamala, Rosario (CL)

(21) Appl. No.: 17/901,137

(22) Filed: Sep. 1, 2022

Related U.S. Application Data
(60) Provisional application No. 63/240,485, filed on Sep. 3, 2021.

(51) Int. Cl. A01N 37/44

(52) U.S. Cl. CPC A01N 37/44

(57) ABSTRACT

The present invention relates to methods of reducing crop load of woody perennial plants comprising applying 1-amino-1-cyclopropanecarboxylic acid to the plants prior to bloom.

### FIELD OF THE INVENTION

The present invention relates to methods of reducing crop load of woody perennial plants comprising applying 1-amino-l-cyclopropanecarboxylic acid or a hydrate thereof, a polymorph thereof or a salt thereof to the plants prior to bloom.

### BACKGROUND OF THE INVENTION

Stone fruits such as almond, apricot, cherry, nectarine, peach, and plum are important perennial fruit crops in the US and around the world. There is an increasing emphasis on producing larger fruit of high quality, as opposed to volume of fruit (tonnage). Growers are now challenged to produce crops of uniformly large fruit with adequate color and optimal flavor as consumers have grown to expect high quality fruit on a year-round basis.

Reduction of the crop load on a tree (thinning) is often used to produce high quality tree fruit. During flowering and fruit set, growers commonly physically or chemically remove flowers (flower thinning) or young fruit (fruitlet thinning) to maximize the size and quality of the remaining fruit (Dennis, 2000, Plant Growth Reg. 31: 1-16). In general, the earlier the crop load is ‘thinned’ the better the quality of fruit at harvest. Removal of flowers or fruitlets on each tree by hand (hand thinning) often provides consistent results but can be prohibitively expensive.

The use of chemicals for cost-effective flower or fruitlet thinning is preferable. The cytokinin 6-benzyladenine (6BA) is an important post-bloom thinning chemical and is particularly effective for increasing fruit size. However, 6BA-induced thinning is sensitive to physiological and weather conditions (Yuan and Greene, 2000, J. Amer. Soc. Hort. Sci. 125: 169-176). The chemical insecticide carbaryl is often used for post-bloom thinning apple fruitlets (Petracek et al., 2003, HortScience. 38: 937-942). However, carbaryl faced regulatory challenges and is no longer available to growers in some regions as it harmful to bees. Harm to bees is also why carbaryl cannot be applied during bloom. For stone fruit such as peaches, 1-amino-1-cyclopropanecarboxylic acid has been demonstrated to induce thinning when applied during or after bloom. See, U.S. Pat. No. 8,435,929.

Most chemical thinners are applied post-bloom. To date there is no widely accepted chemical thinner for pre-bloom application. However, pre-bloom thinning has several benefits including reduction in flower number leading to less wasting of resources to fruitlets that will eventually be thinned. Further, there should be sufficient flower buds remaining to endure losses from frost.

Thus, there is a need in the art for an effective chemical thinner capable of reducing crop load when applied prior to bloom.

### SUMMARY OF THE INVENTION

The present invention is directed to methods of reducing crop load of woody perennial plants comprising applying 1-amino-1-cyclopropanecarboxylic acid or a hydrate thereof, a polymorph thereof or a salt thereof to the plants prior to bloom.

The present invention is further directed to reducing crop load in stone fruit or pome fruit trees comprising applying 1-amino-1-cyclopropanecarboxylic acid or a hydrate thereof, a polymorph thereof or a salt thereof to the plants prior to bloom.

### DETAILED DESCRIPTION OF THE INVENTION

Applicant has unexpectedly discovered that application of 1-amino-1-cyclopropanecarboxylic acid (“ACC”) prior to bloom effectively reduced crop load such that fruit was larger and or of higher quality at harvest.

ACC has been the subject of several recent patent applications by the Applicant including for fruit thinning including WO2010144779, WO2018183674, WO2018183680, WO2018183686, WO2018207693, and WO2018207694. Each of these patent applications listed are incorporated by reference herein as the ACC salts, hydrates, polymorphs, and formulations disclosed in these patent applications may be used in methods of the present invention.

ACC can be used in the form of salt derived from inorganic or organic acids or bases. Acid addition salts of the active ingredients of the present invention can be prepared in situ during the final isolation and purification of the compounds of the invention or separately by reacting a free base function with a suitable organic acid. Representative acid addition salts include, but are not limited to acetate, adipate, alginate, aspartate, benzoate, benzenesulfonate, bisulfate, butyrate, camphorate, camphorsulfonate, digluconate, glycerophosphate, hemisulfate, heptanoate, hexanoate, fumarate, hydrochloride, hydrobromide, hydroiodide, 2-hydroxyethansulfonate (isothionate), lactate, maleate, methanesulfonate, nicotinate, 2-naphthalenesulfonate, oxalate, palmitoate, pectinate, persulfate, 3-phenylpropionate, picrate, pivalate, propionate, succinate, tartrate, thiocyanate, phosphate, glutamate, bicarbonate, p-toluenesulfonate and undecanoate. Also, the basic nitrogen-containing groups can be quaternized with such agents as lower alkyl halides such as methyl, ethyl, propyl, and butyl chlorides, bromides and iodides; dialkyl sulfates like dimethyl, diethyl, dibutyl and diamyl sulfates; long chain halides such as decyl, lauryl, myristyl and stearyl chlorides, bromides and iodides; arylalkyl halides like benzyl and phenethyl bromides and others. Water or oil-soluble or dispersible products are thereby obtained. Examples of acids which can be employed to form acid addition salts include such inorganic acids as hydrochloric acid, hydrobromic acid, hyaluronic acid, and phosphoric acid and such organic acids as oxalic acid, maleic acid, methanosulfonic acid, and succinic acid. Basic addition salts can be prepared in situ during the final isolation and purification of compounds of this invention by reacting a carboxylic acid-containing moiety with a suitable base such as the hydroxide, carbonate or bicarbonate of a pharmaceutically acceptable metal cation or with ammonia or an organic primary, secondary or tertiary amine. Salts include, but are not limited to, cations based on alkali metals or alkaline earth metals such as lithium, sodium, potassium, calcium, magnesium and aluminum salts and the like and nontoxic quaternary ammonia and amine cations including ammonium, tetramethylammonium, tetraethylammonium, methylammonium, dimethylammonium, trimethylammonium, triethylammonium, diethylammonium, and ethylammonium among others. Other representative organic amines useful for the formation of base addition salts include ethylenediamine, ethanolamine, diethanolamine, piperidine, piperazine and the like.

Hydrates of ACC suitable for use in the present invention include ACC trihydrate and ACC anhydrate.

The present invention is directed to methods of reducing crop load of woody perennial plants comprising applying ACC or a hydrate thereof, a polymorph thereof or a salt thereof to the plants prior to bloom.

Woody perennial plants refer to plants with stems that do not die back to the ground from which they grew and include, but are not limited to, grape vines, kiwifruit vines, stone fruit trees, pome fruit trees, blueberry bushes and brambles including raspberry and blackberry and cultivars, varieties and hybrids thereof.

Stone fruit trees, include but are not limited to, peach trees, nectarine trees, plum trees, apricot trees, and cherry trees and cultivars, varieties and hybrids thereof.

Pome fruit trees, include but are not limited to, apple, azarole, crabapple, loquat, mayhaw, medlar, pear, Asian pear, quince, Chinese quince, Japanese quince, tejocote and cultivars, varieties and hybrids thereof.

In a preferred embodiment, the present invention is directed to reducing crop load in stone fruit or pome fruit trees comprising applying ACC or a hydrate thereof, a polymorph thereof or a salt thereof to the plants prior to bloom.

In an even more preferred embodiment, the present invention is directed to reducing crop load in stone fruit trees comprising applying ACC or a hydrate thereof, a polymorph thereof or a salt thereof to the plants prior to bloom.

In an even more preferred embodiment, the present invention is directed to reducing crop load in peach trees comprising applying ACC or a hydrate thereof, a polymorph thereof or a salt thereof to the plants prior to bloom.

In methods of the present invention ACC or a hydrate thereof, a polymorph thereof or a salt thereof is applied to plants prior to bloom. In a preferred embodiment, ACC or a hydrate thereof, a polymorph thereof or a salt thereof is applied after budding and prior to bloom. In a most preferred embodiment, ACC or a hydrate thereof, a polymorph thereof or a salt thereof is applied to peach trees at the pink bud stage.

As used herein the term “bud” or “budding” refers to a stage in the developmental life cycle of the plant in which a flower bud first becomes visible until the time immediately prior to the time the flower petals within the bud first become visible.

As used herein the term “bloom” or “blooming” refers to a stage in the developmental life cycle of a plant in which the flower petals first become visible to the time the petals begin to fall off the plant.

The peach tree flower bud growth stages are as follows: 1) dormant-the buds are tight with no visible swelling; 2) bud swell-buds are swollen; 3) green calyx, green bud, or bud burst-top of buds have opened; 4) pink bud-buds have expanded and elongated; 5) first bloom-when the first flowers open; 6) full bloom-when most flowers on the tree are open; 7) petal fall-when the petals fall from the tree; 8) shuck split-growth of fruit has split the flower shuck; and 9) shuck off-growth of fruit has pushed the flower shuck off the blossom end of the fruit.

In another preferred embodiment, ACC or a hydrate thereof, a polymorph thereof or a salt thereof is applied to the plant at a rate from about 1 to 5,000 parts per million (“ppm”), more preferably from about 10 to about 2,000 ppm, even more preferably from about 100 to about 1,000 ppm and yet even more preferably from about 300 to about 600 ppm.

The plum tree flower bud growth stages are similar to that of the peach tree except that the pink bud stage is known as the white bud stage.

As used herein, “effective rate” refers to the rate at which ACC or a hydrate thereof, a polymorph thereof or a salt thereof is applied which will result in reduction of crop load or thinning. The “effective rate” will vary depending on the plant species or variety being treated, the result desired, and the life stage of the plants, among other factors. Thus, it is not always possible to specify an exact “effective rate.”

The ACC or a hydrate thereof, a polymorph thereof or a salt thereof can be applied by any convenient means. Those skilled in the art are familiar with the modes of application that include foliar applications such as spraying, dusting, and granular applications; soil applications including spraying, in-furrow treatments, or side-dressing. In a preferred embodiment, ACC or a hydrate thereof, a polymorph thereof or a salt thereof is applied to the plant as a spray and even more preferably as a foliar spray.

As used herein, all numerical values relating to amounts, weight percentages and the like are defined as “about” or “approximately” each particular value, namely, plus or minus 10% (±10%). For example, the phrase “at least 5% by weight” is to be understood as “at least 4.5% to 5.5% by weight.” Therefore, amounts within 10% of the claimed values are encompassed by the scope of the claims.

Throughout the application, the singular forms “a,” “an,” and “the” include plural reference unless the context clearly dictates otherwise.

As used herein, all numerical values relating to amounts, weight percentages and the like that are defined as “about” or “approximately” each particular value denotes plus or minus 10% of that particular value. For example, the phrase “about 10% w/w” is to be understood as encompassing values from 9% to 11% w/w. Therefore, amounts within 10% of the claimed values are encompassed by the scope of the invention.

The invention is demonstrated by the following representative examples. These examples are offered by way of illustration only and not by way of limitation.

### EXAMPLES

Regulaid® was used as the source of 2-butoxyethanol, poloxalene, monopropylene glycol (Regulaid is a registered trademark of and available from Kalo, Inc).

### Example 1-Peach Tree Thinning

### Method

Thinning trials were conducted in Coloma, Mich. in May 2018. Specifically, 1-amino-1-cyclopropanecarboxylic acid was prepared at 300 and 600 ppm ACC solutions with 0.05% 2-butoxyethanol, poloxalene, monopropylene glycol as a surfactant. These solutions were applied as a foliar spray to GlenGlo Peach trees at pink bud stage, full bloom and after petal fall. Three one year-old shoots were flagged for each treatment on eight replicate trees. Fruit and defoliation were evaluated four weeks after bloom applications and two weeks after the post-petal fall application. Table 1, below, demonstrates the effect of the application of 300 or 600 ppm ACC solution on these stone fruit trees. Thinning activity is expressed as fruit set (the number of large fruit per 100 flowers). Table 2, below, demonstrates effect of the ACC application on foliage quality wherein 1 is the best and 3 is the worst.

TABLE 1

| Treatment | Application Timing | % Fruit Set |
|---|---|---|
| 0.05% Surfactant Control | Pink Bud Stage | 41 |
| 300 ppm ACC | Pink Bud Stage | 10 |
| 600 ppm ACC | Pink Bud Stage | 6 |
| 0.05% Surfactant Control | Full Bloom | 46 |
| 300 ppm ACC | Full Bloom | 10 |
| 600 ppm ACC | Full Bloom | 1 |
| 0.05% Surfactant Control | After Petal Fall | 48 |
| 300 ppm ACC | After Petal Fall | 57 |
| 600 ppm ACC | After Petal Fall | 45 |

TABLE 2

| Treatment | Application Timing | Foliage Rating |
|---|---|---|
| 0.05% Surfactant Control | Pink Bud Stage | 1.29 |
| 300 ppm ACC | Pink Bud Stage | 1.52 |
| 600 ppm ACC | Pink Bud Stage | 1.95 |
| 0.05% Surfactant Control | Full Bloom | 1.95 |
| 300 ppm ACC | Full Bloom | 2.10 |
| 600 ppm ACC | Full Bloom | 2.67 |
| 0.05% Surfactant Control | After Petal Fall | 1.62 |
| 300 ppm ACC | After Petal Fall | 1.86 |
| 600 ppm ACC | After Petal Fall | 1.90 |

### Results

As demonstrated in Table 1, above, the application of ACC significantly thinned peach trees in reference to the surfactant only control in a dose-dependent manner when applied at either the pink bud stage or during full bloom. Specifically, application of ACC at the pink bud stage reduced fruit set 310% over control at 300 ppm and 583% over control at 600 ppm. However, application after petal fall did not provide effective thinning activity. Thus, pre-bloom application of ACC provides effective thinning of stone fruit trees. Further, as demonstrated in Table 2, above, application of ACC at the pink bud stage did not significantly reduce foliage quality of the stone fruit trees.

### Example 2-Peach and Nectarine Tree Thinning

### Method

Thinning trials were conducted Greece, Italy and Spain in 2020. Specifically, 1-amino-1-cyclopropanecarboxylic acid was prepared at 200, 300, 400, 500, 800 and 1,000 ppm ACC solutions. These solutions were applied as a foliar spray to peach trees (i.e. Spain North, Spain South #1 and Greece #2) and nectarine trees (i.e. Spain South #1 and Greece #1) at pink bud stage. Table 3, below, demonstrates the effect of the application of ACC solution on these stone fruit trees. Thinning activity is expressed as fruit set (the number of large fruit per 100 flowers).

TABLE 3

| | | | % | | | | |
|---|---|---|---|---|---|---|---|
| | % | % | Fruit | % | % | | |
| | Fruit | Fruit | Set | Fruit | Fruit | % | % |
| | Set | Set | (Spain | Set | Set | Fruit | Fruit |
| | (Spain | (Spain | South | (Greece | (Greece | Set | Set |
| Treatment | North) | South#1) | #2) | #1) | #2) | (Italy) | (Avg) |
| Untreated | 72 | 69 | 65 | 34 | 38 | 34 | 52 |
| Control | | | | | | | |
| 200 ppm | 50 | 55 | 55 | 37 | 33 | 33 | 44 |
| ACC | | | | | | | |
| 300 ppm | 44 | 46 | 55 | 32 | 32 | 32 | 40 |
| ACC | | | | | | | |
| 400 ppm | 33 | 39 | 48 | 28 | 28 | 34 | 35 |
| ACC | | | | | | | |
| 500 ppm | 25 | 42 | 45 | 25 | 28 | 32 | 33 |
| ACC | | | | | | | |
| 800 ppm | 7 | 31 | 37 | 19 | 23 | 32 | 25 |
| ACC | | | | | | | |
| 1,000 ppm | 7 | 32 | 37 | 16 | 21 | 31 | 24 |
| ACC | | | | | | | |

### Results

As demonstrated in Table 3, above, the application of ACC significantly thinned peach and nectarine trees in reference to the untreated control in a dose-dependent manner when applied at the pink bud stage. Specifically, application of ACC at the pink bud stage reduced fruit set on average 18% over control at 200 ppm, 30% over control at 300 ppm, 49% over control at 400 ppm, 58% over control at 500 ppm, 108% over control at 800 ppm and 117% over control at 1,000 ppm. Thus, pre-bloom application of ACC provides effective thinning of stone fruit trees.

### Example 3-Plum Tree Thinning

### Method

Thinning trials were conducted Chile in 2020. Specifically, 1-amino-1-cyclopropanecarboxylic acid was prepared at 300 and 450 ppm ACC solutions. These solutions were applied as a foliar spray to two separate varieties of plum trees (i.e. Candy Stripe and Black Majesty) at the white bud stage, the full bloom stage or the petal fall stage. Table 4, below, demonstrates the effect of the application of ACC solution on these stone fruit trees. Thinning activity is expressed as fruit set (the number of large fruit per 100 flowers).

TABLE 4

| | | % | % | |
|---|---|---|---|---|
| | | Fruit set | Fruit Set | % |
| | Application | ‘Candy | ‘Black | Fruit Set |
| Treatment | Timing | Stripe’ | Majesty’ | (Avg) |
| Untreated Control | | 23 | 25 | 24 |
| 300 ppm ACC | White Bud Stage | 1 | 4 | 2.5 |
| 450 ppm ACC | White Bud Stage | 1 | 5 | 3 |
| 300 ppm ACC | Full Bloom Stage | 4 | 9 | 6.5 |
| 450 ppm ACC | Full Bloom Stage | 4 | 9 | 6.5 |
| 300 ppm ACC | Petal Fall Stage | 5 | 8 | 6.5 |
| 450 ppm ACC | Petal Fall Stage | 3 | 8 | 5.5 |

As demonstrated in Table 4, above, the application of ACC significantly thinned plum trees in reference to the untreated control when applied at the white bud stage. Specifically, application of ACC at the white bud stage reduced fruit set on average 21.5% over control at 300 ppm, and 21% over control at 450 ppm. Thus, pre-bloom application of ACC provides effective thinning of stone fruit trees.

What is claimed is:

1. A method of reducing crop load of a woody perennial plant comprising applying 1-amino-1-cyclopropanecarboxylic acid (ACC) or a hydrate thereof, a polymorph thereof or a salt thereof at an effective rate to the plant prior to bloom.

2. The method of claim 1, wherein the woody perennial plant is selected from the group consisting of grape vines, kiwifruit vines, stone fruit trees, pome fruit trees, blueberry bushes and brambles and cultivars, varieties and hybrids thereof.

3. The method of claim 2, wherein the woody perennial plant is a stone fruit tree.

4. The method of claim 3, wherein the stone fruit tree is a peach tree, a nectarine tree or a plum tree.

5. The method of claim 1, wherein the ACC or a hydrate thereof, a polymorph thereof or a salt thereof is applied to the plant from the bud stage to prior to bloom.

6. The method of claim 1, wherein the effective rate is from about 1 to about 5,000 parts per million (ppm).

7. The method of claim 6, wherein the effective rate is from about 10 to about 2,000 ppm.

8. The method of claim 7, wherein the effective rate is from about 100 to about 1,000 ppm.

9. The method of claim 1, wherein the ACC or a hydrate thereof, a polymorph thereof or a salt thereof is applied to the plant as a spray.

10. The method of claim 9, wherein the spray is a foliar spray.

11. A method of reducing crop load of a peach tree or a plum tree comprising applying 1-amino-1-cyclopropanecarboxylic acid (ACC) or a hydrate thereof, a polymorph thereof or a salt thereof at an effective rate to the tree prior to bloom.

12. The method of claim 11, wherein the ACC or a hydrate thereof, a polymorph thereof or a salt thereof is applied to the tree from the bud stage to prior to bloom.

13. The method of claim 12, wherein the ACC or a hydrate thereof, a polymorph thereof or a salt thereof is applied to the peach or the nectarine tree at the pink bud stage or the plum tree at the white bud stage.

14. The method of claim 1, wherein the effective rate is from about 1 to about 5,000 parts per million (ppm).

15. The method of claim 14, wherein the effective rate is from about 10 to about 2,000 ppm.

16. The method of claim 15, wherein the effective rate is from about 100 to about 1,000 ppm.

17. The method of claim 11, wherein the ACC or a hydrate thereof, a polymorph thereof or a salt thereof is applied to the tree as a spray.

18. The method of claim 17, wherein the spray is a foliar spray.

19. A method of reducing crop load of a peach tree, a nectarine tree or a plum tree comprising applying 1-amino-1-cyclopropanecarboxylic acid (ACC) or a hydrate thereof, a polymorph thereof or a salt thereof at a rate from about 100 to 1,000 parts per million to the peach tree or the nectarine tree at the pink bud stage or the plum tree at the white bud stage.

20. The method of claim 19, wherein the ACC or a hydrate thereof, a polymorph thereof or a salt thereof is applied to the tree at a foliar spray.
